(19) United States
(12) Patent Application Publication
(10) Pub. No.: US 2016/0180169 A1
(43) Pub. Date: Jun. 23, 2016

(54) IRIS RECOGNITION DEVICE, IRIS RECOGNITION SYSTEM INCLUDING THE SAME AND METHOD OF OPERATING THE IRIS RECOGNITION SYSTEM

(71) Applicant: Samsung Electronics Co., Ltd., Suwon-si (KR)

(72) Inventors: Kwang Hyuk BAE, Seoul (KR); Chae Sung KIM, Seoul (KR); Dong Ki MIN, Seoul (KR)

(21) Appl. No.: 14/973,694

(22) Filed: Dec. 17, 2015

(30) Foreign Application Priority Data
Dec. 17, 2014 (KR) 10-2014-0182712

(51) Int. Cl. G06K 9/00; H04N 5/33

(52) U.S. Cl. CPC G06K 9/00604; G06K 9/0061; G06K 9/00617; G06K 9/00228; H04N 5/33

(57) ABSTRACT

An iris recognition device includes a first lens and a second lens configured to capture images for recognizing a user's iris; a first filter configured to filter an image input via the first lens and output a first signal; a second filter configured to filter an image input via the second lens and output a second signal; and an image sensor including a plurality of sub-pixel groups which each include a plurality of pixels and are configured to receive the first and second signals and output a first image signal and a second image signal that respectively correspond to the first and second signals.

### CROSS-REFERENCE TO RELATED APPLICATION

This application claims the benefit of Korean Patent Application No. 10-2014-0182712 filed on Dec. 17, 2014, in the Korean Intellectual Property Office, the disclosure of which is incorporated herein in its entirety by reference.

### BACKGROUND

One or more exemplary embodiments of the inventive concept relate to an iris recognition device, an iris recognition system including the same and a method of operating the iris recognition system, and more particularly, to an iris recognition device capable of precisely measuring an iris within a short time, an iris recognition system including the same and a method of operating the iris recognition system.

An iris recognition system is an apparatus configured to identify a person based on a fact that people have different iris characteristics. Since the iris characteristics cannot be duplicated or forged, the iris recognition system has been used for security, crime prevention, identification and authentication, etc.

The iris recognition system performs iris recognition by capturing an image of a user's eyes using an image sensor within an appropriate distance from the user, processing the image, and comparing the image with an image stored beforehand.

To this end, the iris recognition system displays a result of measuring a distance from the user using a distance-measuring sensor so that the user may be positioned within an operating range.

In the image sensor configured to capture an image of the user's eyes, a wide-angle view camera is used to capture images of users' eyes having various lengths or a narrow-angle view camera is used to expand and capture an image of only a user's eyes.

If the wide-angle view camera is used, an angle of view is large. Thus, a high-resolution camera is required and a data throughput increases. If the narrow-angle view camera is used, an optical axis is difficult to be adjusted when a user takes close-up pictures and a shaded portion may be generated in a captured image due to lighting. Also, a user's iris may be hidden when light is reflected according to an angle between a user and the lighting.

Thus, there is a need to develop a method of easily and precisely capture an image of a user's iris.

### SUMMARY

According to an aspect of the inventive concept, an iris recognition device includes a first lens and a second lens configured to capture images for recognizing a user's iris; a first filter configured to filter an image input via the first lens, and output a first signal; a second filter configured to filter an image input via the second lens, and output a second signal; and an image sensor including a plurality of sub-pixel groups which each include a plurality of pixels and are configured to receive the first and second signals and output a first image signal and a second image signal that respectively correspond to the first and second signals. The first image signal is an image signal obtained by photographing the user's eyes, and the second image signal is an image signal obtained by photographing the user's face.

In one embodiment, the plurality of sub-pixel groups may include a first sub-pixel group and a second sub-pixel group configured to receive the first signal, and a third sub-pixel group configured to receive the second signal.

In one embodiment, the first filter may be an infrared-ray (IR) band pass filter, and the second filter may be an IR cut filter.

In one embodiment, an exposures time of pixels included in the first and second sub-pixel group may be different from an exposure time of pixels included in the third sub-pixel group.

In one embodiment, the first lens may include two narrow-angle lenses, and the second lens may include one wide-angle lens. The two narrow-angle lenses may be respectively disposed on the first and second sub-pixel groups, and the wide-angle lens may be disposed on the third sub-pixel group.

In one embodiment, locations of the two narrow-angle lenses and the wide-angle lens are optimized through micro-lens shift control.

According to another aspect of the inventive concept, an iris recognition system includes an iris recognition device configured to capture images for recognizing a user's iris, and output a first image signal and a second image signal based on the captured images; and an iris image processor configured to calculate distance information and spatial information regarding the user's face according to the first and second image signals, and determine whether the first image signal is identical to a predetermined image signal based on the calculated distance information and spatial information.

In one embodiment, the iris image processor may include a matching unit configured to match the first and second image signals, and calculate the distance information based on a result of matching the first and second image signals; a face detection unit configured to calculate the spatial information based on the second image signal; a determination unit configured to determine whether the user's face is positioned in an operating region, based on the distance information and the spatial information; and an iris detection unit configured to determine whether the first image signal is identical to the predetermined image signal and output a result of determining whether the first image signal is identical to the predetermined image signal, when the user's face is positioned in the operating region.

In one embodiment, the iris recognition system may further include an image signal processor configured to extract a luminance component from the second image signal, output the luminance component to the matching unit, extract an RGB component from the second image signal, and output the RGB component to the face detection unit. The matching unit may match the first image signal with the luminance component of the second image signal.

In one embodiment, the iris recognition device may include an image sensor including a first sub-pixel group and a second sub-pixel group configured to output the first image signal corresponding to an image input via a first lens, and a third sub-pixel group configured to output the second image signal corresponding to an image input via a second lens.

In one embodiment, an exposure time of pixels included in the first and second sub-pixel groups may be different from an exposure time of pixels included in the third sub-pixel group.

In one embodiment, the first lens may include two narrow-angle lenses, and the second lens may include one wide-angel lens. The two narrow-angle lenses may be respectively disposed on the first and second sub-pixel groups, and the wide-angle lens may be disposed on the third sub-pixel group.

In one embodiment, the first image signal may be based on an infrared-ray image obtained by photographing the user's eyes, and the second image signal may be based on a visible-ray image obtained by photographing the user's face.

In one embodiment, sizes of pixels included in the first and second sub-pixel groups may be greater than sizes of pixels included in the third sub-pixel group.

In one embodiment, binning may be performed on the pixels included in the first and second sub-pixel groups to generate a piece of pixel data from data detected from at least two pixels among the pixels.

According to another aspect of the inventive concept, a method of operating an iris recognition system includes outputting a first image signal and a second image signal by capturing images for recognizing a user's iris; calculating distance information regarding the user by matching the first image signal and the second image signal; calculating spatial information regarding the user's face, based on the second image signal; and performing iris recognition based on the distance information and the spatial information.

In one embodiment, the performing of the iris recognition may include determining whether the user's face is positioned in an operating region, based on the distance information and the spatial information; and determining whether the first image signal is identical to a predetermined image signal when the user's face is positioned in the operating region.

In one embodiment, the first image signal may correspond to an infrared-ray image obtained by photographing the user's eyes, and the second image signal may correspond to a visible-ray image obtained by photographing the user's face.

### BRIEF DESCRIPTION OF THE DRAWINGS

Exemplary embodiments of the inventive concept will be more clearly understood from the following detailed description taken in conjunction with the accompanying drawings in which:

FIG. 1 is a diagram illustrating an example of an image processing system including an iris recognition system in accordance with the teachings herein;

FIG. 2 is a block diagram of the image processing system of FIG. 1;

FIG. 3 is a block diagram of the iris recognition system of FIG. 2 according to an embodiment of the inventive concept;

FIG. 4 is a diagram illustrating an iris recognition device of FIG. 3 according to an embodiment of the inventive concept;

FIG. 5 is a block diagram of an image sensor of FIG. 4 according to an embodiment of the inventive concept;

FIG. 6 is a diagram illustrating a pixel array of the image sensor of FIG. 5;

FIG. 7A and FIG. 7B are diagrams illustrating an operation of the iris recognition system of FIG. 3 according to an embodiment of the inventive concept; and

FIG. 8 is a flowchart of a method of operating the iris recognition system of FIG. 3 according to an embodiment of the inventive concept.

### DETAILED DESCRIPTION OF THE EMBODIMENTS

The concepts presented will now be described more fully hereinafter with reference to the accompanying drawings. This subject matter disclosed herein may, however, be embodied in many different forms and should not be construed as limited to the embodiments set forth herein. Rather, these embodiments are provided so that this disclosure will be thorough and complete, and will fully convey the scope of the subject matter to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting. As used herein, the singular forms “a”, an and the are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art of the technology disclosed herein. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

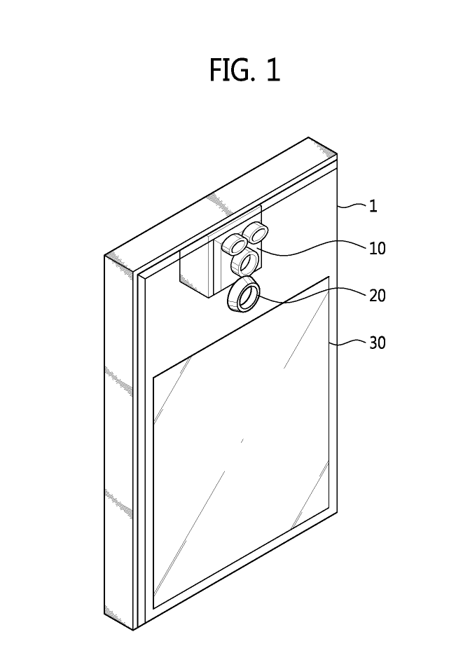

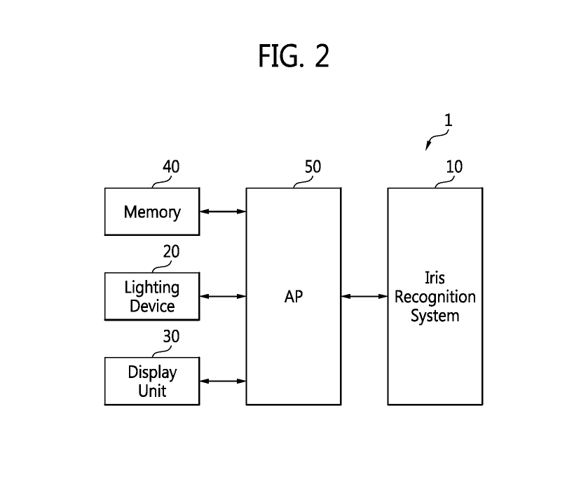

FIG. 1 is a diagram illustrating an embodiment of an image processing system 1 including an iris recognition system 10. FIG. 2 is a block diagram of the image processing system 1 of FIG. 1.

Referring to FIGS. 1 and 2, aspects of the image processing system 1 may be embodied as a portable electronic device. The portable electronic device may be a laptop computer, a mobile phone, a smart phone, a tablet personal computer (PC), a personal digital assistant (PDA), an enterprise digital assistant (EDA), a digital still camera, a digital video camera, a portable multimedia player (PMP), a mobile internet device (MID), a wearable computer, an Internet of things (IoT) device, or an Internet of everything (IoE) device. Other devices with similar capabilities may be used as the portable electronic device. Some components of the image processing system 1 may be implemented remotely from an imaging device.

In illustrative and non-limiting embodiments disclosed herein, the image processing system 1 includes the iris recognition system 10, a lighting device 20, a display unit 30, a memory 40, and an application processor (AP) 50.

The iris recognition system 10 may generate an image signal by capturing images of the face and eyes of a user which are in a field of view for the iris recognition system 10. In various embodiments, the iris recognition system 10 employs three lenses to capture the image signal, and then checks the iris of the user based on the image generated as well as other information.

The lighting device 20 may provide infrared rays toward eyes of a user under control of the AP 50.

The display unit 30 may display image data generated by the image processing system 1 under control of the AP 50. For example, the display unit 30 may be embodied as a liquid crystal display (LCD), a light-emitting diode (LED) display, an organic LED (OLED) display, an active matrix OLED (AMOLED) display, or a flexible display. Other types of displays may be used in the display unit 30.

The memory 40 may store a program for controlling an operation of the image processing system 1. For example, the memory 40 may be embodied as a volatile memory or a nonvolatile memory. In some embodiments, the memory 40 is configured to store machine executable instructions within machine-readable media, where the storage is non-transitory.

The AP 50 may control operations of the elements 10 to 30 included in the image processing system 1. The AP 50 may execute the program stored in the memory 40.

Also, the AP 50 may control the iris recognition system 10 to operate in a front camera mode or an iris recognition mode.

When the iris recognition system 10 operates in the front camera mode, the AP 50 may control the iris recognition system 10 to output only data corresponding to visible-ray images. When the iris recognition system 10 operates in the iris recognition mode, the AP 50 may control the iris recognition system 10 to output data corresponding to visible-ray images and infrared-ray images.

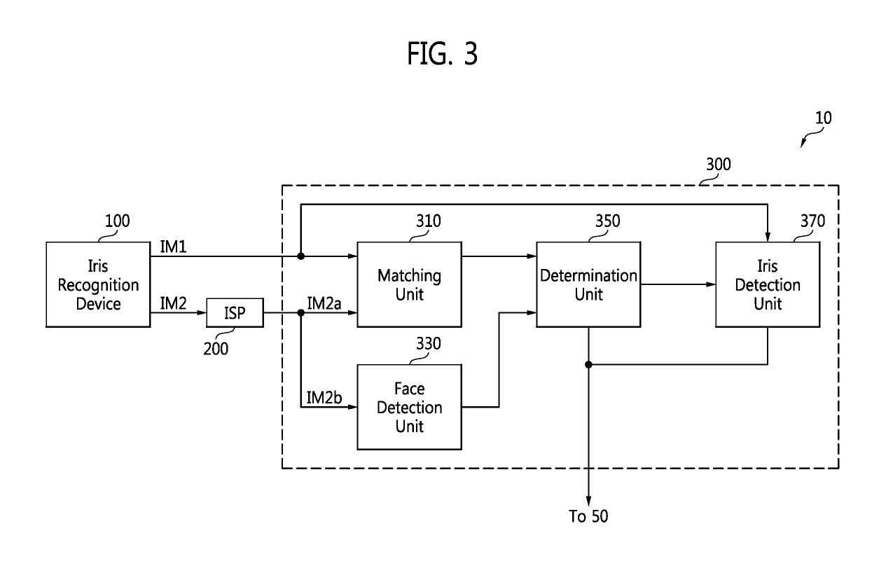

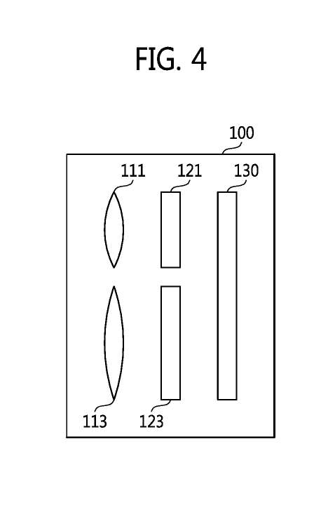

FIG. 3 is a block diagram of an embodiment of the iris recognition system 10 of FIG. 2. FIG. 4 is a diagram illustrating an embodiment of the iris recognition device 100 of FIG. 3.

FIG. 4 illustrates a side surface of the iris recognition device 100.

Referring to FIGS. 1 to 4, the iris recognition system 10 includes the iris recognition device 100, an image signal processor (ISP) 200, and an iris image processor 300. These processors and other processing as may be performed by the iris recognition device 100 may be implemented as machine executable instructions, for example, instructions stored within memory 40. In some embodiments, the image signal processor (ISP) 200 and/or the iris image processor 300 are implemented as hardware devices dedicated to the assigned processing. Processing tasks may be assigned or shared as deemed appropriate.

The iris recognition device 100 captures images for recognizing the iris of the user, and outputs a first image signal IM1 and a second image signal IM2 based on the captured images.

In the embodiments presented herein, the iris recognition device 100 includes a first lens 111, a second lens 113, a first filter 121, a second filter 123, and an image sensor 130.

The first lens 111 and the second lens 113 may include lenses having different angles of view according to a focal length.

The first lens 111 may include two narrow-angle lenses having narrow angles of view to expand and capture images of regions of the eyes of the user. The second lens 113 may include a wide-angle lens having a wide angle of view to capture an image of the face of the user. The first lens 111 may be a zoom lens, and the second lens 113 may be a short focal length lens.

That is, in some embodiments, the iris recognition device 100 may obtain images for recognizing the iris of the user using three lenses.

Although not shown in FIG. 4, the iris recognition device 100 may further include micro-lenses on front ends of the first lens 111 and the second lens 113 to concentrate incident light.

The first filter 121 may allow an infrared-ray image to pass therethrough among images input via the first lens 111, and output a filtered signal, e.g., a filtered optical signal. The second filter 123 may allow a visible-ray (VIS) image to pass therethrough among images input via the second lens 113, and output a filtered signal.

To this end, the first filter 121 may be embodied as an infrared ray (IR) band pass filter configured to pass an infrared-ray image therethrough. The second filter 123 may be embodied as an IR cut filter configured to block an infrared-ray image and pass a visible-ray image therethrough.

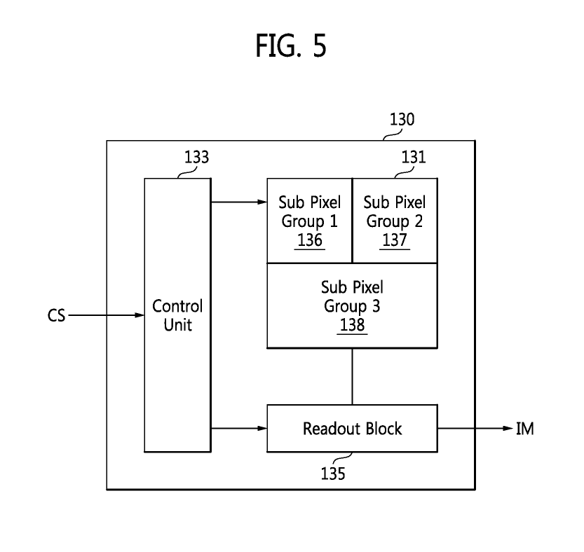

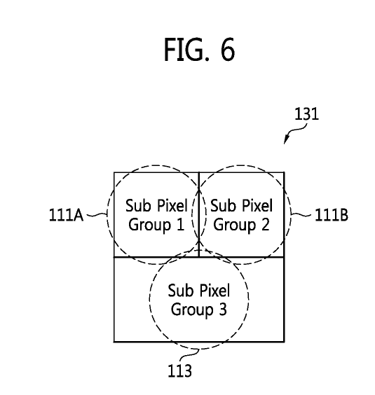

The image sensor 130 may include a plurality of sub-pixel groups which each include a plurality of pixels and are configured to receive filtered optical signals and output image signals corresponding to the filtered optical signals. An example of the image sensor 130 is illustrated in FIGS. 5 and 6.

FIG. 5 is a block diagram of an embodiment of the image sensor 130 of FIG. 4. FIG. 6 is a diagram illustrating a pixel array 131 of the image sensor 130 of FIG. 5.

Referring to FIG. 5, the image sensor 130 includes the pixel array 131, a control unit 133, and a readout block 135.

The pixel array 131 may include a plurality of sub-pixel groups (e.g., a first sub-pixel group 136, a second sub-pixel group 137 and a third sub-pixel group 138) arranged in a matrix. Each of the plurality of sub-pixel groups (e.g., the first sub-pixel groups 136 to the third sub-pixel group 138) may be driven to output a plurality of sub-pixel signals under control of the control unit 133.

In one embodiment, the plurality of sub-pixel groups (136, 137, 138) may include the first sub-pixel group 136 and the second sub-pixel group 137 respectively corresponding to two first lenses 111A and 111B, and the third sub-pixel group 138 corresponding to one second lens 113.

The control unit 133 may control operations of the pixel array 131 and the readout block 135 according to a control signal CS output from the AP 50.

The control unit 133 may control an exposure time of pixels included in the first sub-pixel group 136 and the second sub-pixel group 137 and an exposure time of pixels included in the third sub-pixel group 138 to be different. The exposure time may be differently controlled according to various considerations, e.g., light of the lighting device 20, ambient conditions, sensitivity of the image sensor 130 to selected wavelengths, etc.

For example, when iris recognition is performed in a dark place, the control unit 133 may control an exposure time of pixels corresponding to a visible-ray image to be greater than an exposure time of pixels corresponding to an infrared-ray image.

That is, the image sensor 130 may be divided into a plurality of regions to control an exposure time of pixels differently and corresponding to the first lenses 111A and 111B and an exposure time of pixels corresponding to the second lens 113.

In another embodiment, in order to increase the efficiency of an infrared-ray image, the size of the pixels included in each of the sub-pixel groups may be set to be different sizes in comparison to pixels included in the other sub-pixel groups or binning may be performed on these pixels.

For example, the sizes of the pixels included in the first sub-pixel group 136 and the second sub-pixel group 137 may be configured to output a pixel signal corresponding to an infrared-ray image may be set to be greater than the sizes of the pixels included in the third sub-pixel group 138 configured to output a pixel signal corresponding to a visible-ray image.

Binning may be performed on the pixels included in the first sub-pixel group 136 and second sub-pixel groups 137 to generate a pixel signal from pixel signals detected from at least two pixels among the pixels included in the first sub-pixel group 136 and the second sub-pixel group 137.

To configure the iris recognition device 100, lenses may be formed on the plurality of sub-pixel groups (e.g., the first sub-pixel group 136 to third sub-pixel group 138) included in the pixel array 131 to correspond to the plurality of sub-pixel groups (e.g., the first sub-pixel group 136, the second sub-pixel group 137 and the third sub-pixel group 138) as illustrated in FIG. 6.

Referring to FIG. 6, the two first lenses 111A and 111B may be respectively formed on the first sub-pixel group 136 and the second sub-pixel group 137, and one second lens 113 may be formed on the third sub-pixel group 138. Although not shown in FIG. 6, the first filter 121 may be formed between the first sub-pixel group 136 and the second sub-pixel group 137 and the first lenses 111A and 111B, and the second filter 123 may be formed between the third sub-pixel group 138 and the second lens 113.

In this case, the locations of the first lenses 111A and 111B and the second lens 113 may be optimized through micro-lens shift control.

Here, the term “micro-lens shift control” generally refers to processes for optimizing the locations of the first lenses 111A and 111B and the second lens 113 by changing geometric considerations such as the heights of the pixels of the image sensor 130, the angle of incidence of light, the structures of the first lenses 111A and 111B and the second lens 113, etc.

The readout block 135 receives sub-pixel signals from the plurality of sub-pixel groups (e.g., the first sub-pixel group 136 to third sub-pixel group 138), and generates and outputs an image signal IM.

Under control of the control unit 133, the readout block 135 may generate and output a first image signal IM1 corresponding to the first sub-pixel group 136 and second sub-pixel group 137 and a second image signal IM2 corresponding to the third sub-pixel group 138.

That is, the first image signal IM1 corresponding to an infrared-ray image of the eyes of the user and the second image signal IM2 corresponding to a visible-ray image of the face of the user may be output.

Referring back to FIG. 3, the ISP 200 may process the second image signal IM2 output from the iris recognition device 100, and extract a first component IM2a and a second component IM2b from the second image signal IM2 and output the first component IM2a and the second component IM2b.

That is, the ISP 200 may extract the first component IM2a which may be, for example, a luminance (luma) component and the second component IM2b which is, for example, an RGB component from the second image signal IM2 which is a Bayer signal, and output the first component IM2a and the second component IM2b.

The iris image processor 300 may include a matching unit 310, a face detection unit 330, a determination unit 350, and an iris detection unit 370.

The matching unit 310 matches the first image signal IM1 with the luma component IM2a of the second image signal IM2, and calculates distance information based on a result of matching. The distance information is information representing the distance between the iris recognition device 100 and a user.

That is, the matching unit 310 may calculate distance information between the iris recognition device 100 and the user by matching the locations of the eyes of the user with the location of the face of the user.

The face detection unit 330 calculates spatial information based on the second component IM2b which is a RGB component of the second image signal IM2. The spatial information is information representing a space of a screen that the face of the user occupies when an image captured by the iris recognition device 100 is displayed on the display unit 30.

That is, the face detection unit 330 may calculate the spatial information by detecting an area of the display unit 30 on which the color of the face of the user is displayed.

The determination unit 350 determines whether the face of the user is located within a predetermined operating region based on the distance information and the spatial information, and outputs a result of determining whether the face of the user is located within the predetermined operating region. The operating region should be understood as information representing the range of predetermined values of the distance information and the spatial information.

That is, the determination unit 350 may determine whether the two eyes in an image of the face of the user are disposed to be centrally located relative to an optical axis of the iris recognition device 100.

The determination unit 350 may output a “fail” signal to the AP 50 so as to capture an image of the user again when the user's face is not located within the operating region. For example, the determination unit 350 may output the “fail” signal to the AP 50 when the user is not positioned within a predetermined distance or the face of the user is not positioned in a predetermined space.

In this case, when the AP 50 receives the “fail” signal, the AP 50 may control the image processing system 1 to output a voice message representing that iris recognition fails or to display a guidance message representing that iris recognition fails.

The determination unit 350 may output a capture command signal to the iris detection unit 370 when the face of the user is positioned in the operating region.

The iris detection unit 370 determines whether the first image signal IM1 output from the iris recognition device 100 is identical to or substantially in agreement with predetermined image signal and outputs a result of the determination, according to the capture command signal. In this case, the predetermined image signal is representative of an image of the iris of the user with respect to the image processing system 1. In some embodiments, the predetermined image signal is collected by a training or sampling sequence and stored (for example, in memory 40) prior to the subsequent collection of first image signal IM1.

The iris detection unit 370 may output a “pass” signal to the AP 50 when the first image signal IM1 is identical to the predetermined image signal, and output a “fail” signal to the AP 50 when the first image signal IM1 is not identical to the predetermined image signal.

In this case, when the AP 50 receives the “pass” signal, the AP 50 may control the elements of the image processing system 1 to activate an operation of the image processing system 1. When the AP 50 receives the “fail” signal, the AP 50 may control the image processing system 1 to output a voice message representing that user authentication fails or display a guidance message representing that user authentication fails.

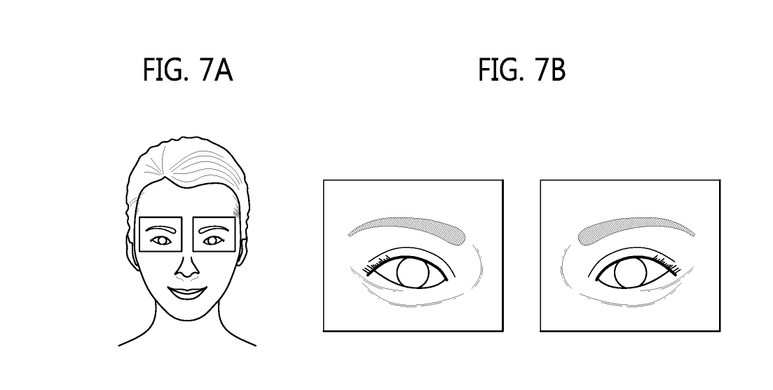

FIG. 7A and FIG. 7B are diagrams illustrating an embodiment for operation of the iris recognition system 10 of FIG. 3. Referring to FIGS. 3,7A and 7B, the iris recognition device 100 captures an image of the face of the user using the second lens 113 as illustrated in FIG. 7A, and captures images of the eyes of the user using the two first lenses 111A and 111B as illustrated in FIG. 7B.

In this case, the image of the face of the user may be a visible-ray image obtained by the second filter 123, and the images of the eyes of the user may be infrared-ray images obtained by the first filter 121.

That is, when the face of the user is positioned in an operating region as illustrated in FIG. 7A, the iris image processor 300 may recognize the iris of the user as illustrated in FIG. 7B.

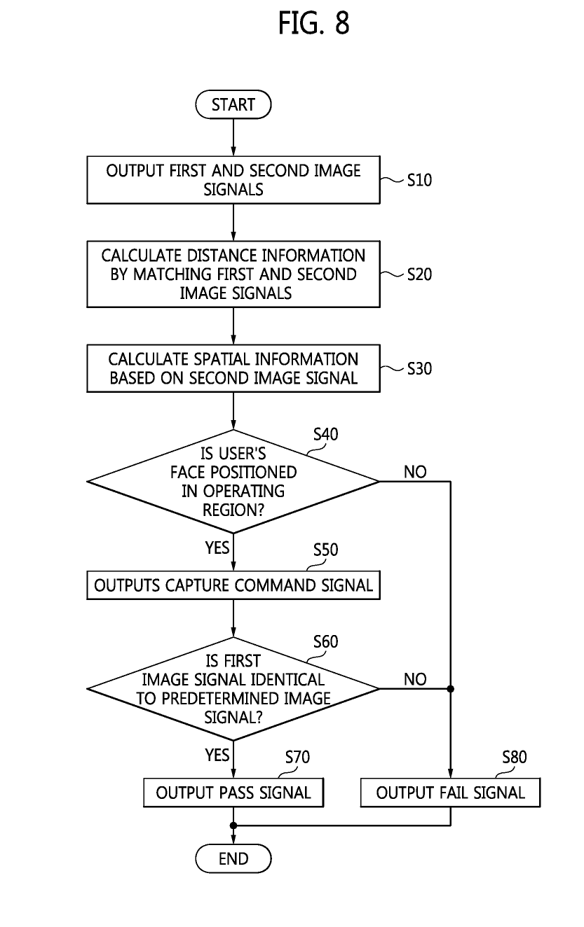

FIG. 8 is a flowchart presenting an embodiment of a method of operating the iris recognition system 10 of FIG. 3. Referring to FIGS. 1 to 8, the iris recognition device 100 captures images for recognizing the iris of a user, and outputs a first image signal IM1 and a second image signal IM2 based on the captured images (operation S10).

The matching unit 310 calculates distance information regarding the user by matching the first image signal IM1 with a luma component IM2a of the second image signal IM2 (operation S20). The face detection unit 330 calculates spatial information regarding the user's face, based on an RGB component IM2b of the second image signal IM2 (operation S30).

The determination unit 350 determines whether the face of the user is positioned in an operating region, based on the distance information and the spatial information (operation S40). When the face of the user is positioned in the operating region, the determination unit 350 outputs a capture command signal (operation S50).

The iris detection unit 370 determines whether the first image signal IM1 is identical to a predetermined image signal according to the capture command signal (operation S60).

When the first image signal IM1 is identical to the predetermined image signal, the iris detection unit 370 determines that user authentication succeeds and outputs a “pass” signal to the AP 50 (operation S70). When the first image signal IM1 is not identical to the predetermined image signal, the iris detection unit 370 determines that user authentication fails and outputs a “fail” is just for signal to the AP 50 (operation S80).

When it is determined in operation S40 that the face of the user is not positioned in the operating region, the determination unit 350 determines that iris recognition fails and outputs a “fail” signal to the AP 50 (operation 80). The AP 50 may activate an operation of the image processing system 1 when the AP 50 receives the “pass” signal, and control the iris recognition device 100 to capture an image of the user again when the AP 50 receives the “fail” signal.

Aspects of the technology disclosed herein may also be embodied as computer-readable codes on a computer-readable medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices.

The computer-readable recording medium can also be distributed over network coupled computer systems so that the computer-readable code is stored and executed in a distributed fashion. Also, functional programs, codes, and code segments to accomplish the teachings herein can be easily construed by programmers.

In some embodiments, the computer-readable medium is non-transitory, and capable of storing computer-readable codes thereon.

With an iris recognition device, an iris recognition system including the same, and a method of operating the iris recognition system, the iris of a user may be very precisely measured within a short time by adjusting an optical axis to coincide with the face of the user.

Having introduced aspects of the iris recognition device, some further features and embodiments are now set forth.

As discussed herein, the terms “RGB” and “RGB component” as well as other similar terms generally refer to standards for implementation of a color space. Other standards for color spaces are known. Color space models may be additive or subtractive.

For example, some common additive color space models include e sRGB, Adobe RGB, ProPhoto RGB, scRGB, and CIE RGB. CMYK is a commonly used subtractive color space model. Many other models for color spaces are known. Any color space deemed appropriate may be employed.

As discussed herein, the term “optical signal” generally refers to infrared (IR) visible (VIS) and use of other wavelengths as deemed appropriate for illumination of an image sensor. The image sensor provides for sensing of the optical signals and generation of image signals.

Generally, as discussed herein, the term “image signal” is with reference to data produced by the image sensor 130. It should be recognized, that the image signal may be stored in a nonvolatile form, and may therefore be, at least in some cases, more appropriately referred to as “image data.” It is further recognized that in order for processing of image data, such as by comparison of one set of image data to another set of image data (such as by comparison of a recently acquired image signal to a predetermined image signal) that image data may be read from memory (such as memory 40) by one or more processors. Accordingly, at least in this sense, an image signal should be construed as including image data that is provided in a non-transitory form.

In some embodiments, a portion of the iris recognition system is implemented by one party, while another portion is implemented by a second party. For example, in some embodiments, imaging is performed by a first party (such as a user, a security company, a security service, or similar party), while data analysis is implemented by a second party (such as a remote service provider). In some of these embodiments, the iris recognition system may be implemented as a partially remote system (such as where remote processing capabilities are provided. A partially remote system may be implemented over a network.

While the teachings herein have been particularly shown and described with reference to the various examples of embodiments provided, it will be understood that various changes in form and details may be made therein without departing from the spirit and scope of the following claims.

What is claimed is:

1. An iris recognition device comprising:
a first lens and a second lens configured to capture images for recognizing an iris of a user;
a first filter configured to filter an image input via the first lens, and output a first signal;
a second filter configured to filter an image input via the second lens, and output a second signal; and
an image sensor including a plurality of sub-pixel groups which each include a plurality of pixels and are configured to receive the first signal and the second signal and output first image data and second image data that respectively correspond to the first signal and the second signal,
wherein the first image data is obtained by photographing eyes of the user, and
wherein the second image data is obtained by photographing a face of the user.

2. The iris recognition device of claim 1, wherein the plurality of sub-pixel groups comprise:
a first sub-pixel group and a second sub-pixel group configured to receive the first signal, and
a third sub-pixel group configured to receive the second signal.

3. The iris recognition device of claim 2, wherein the first filter is an infrared-ray (IR) band pass filter, and
the second filter is an IR cut filter.

4. The iris recognition device of claim 3, wherein an exposure time of pixels included in the first sub-pixel group and the second sub-pixel group is different from an exposure time of pixels included in the third sub-pixel group.

5. The iris recognition device of claim 3, wherein the first lens comprises two narrow-angle lenses, and
the second lens comprises one wide-angle lens,
wherein the two narrow-angle lenses are respectively disposed on the first sub-pixel group and the second sub-pixel group, and
the wide-angle lens is disposed on the third sub-pixel group.

6. The iris recognition device of claim 5, wherein locations of the two narrow-angle lenses and the wide-angle lens are optimized through micro-lens shift control.

7. An iris recognition system comprising:
an iris recognition device configured to capture optical signals for recognizing an iris of a user, and output first image data and second image data based on the captured optical signals; and
an iris image processor configured to calculate distance information and spatial information regarding a face of the user according to the first image data and the second image data, and determine whether the first image signal is substantially identical to predetermined image data based on the calculated distance information and spatial information.

8. The iris recognition system of claim 7, wherein the iris image processor comprises:
a matching unit configured to match the first image data and the second image data, and calculate the distance information based on a result of matching the first image data and the second image data;
a face detection unit configured to calculate the spatial information based on the second image data;
a determination unit configured to determine whether the face of the user is positioned in an operating region, based on the distance information and the spatial information; and
an iris detection unit configured to determine whether the first image data is substantially identical to the predetermined image data and output a result of the determination, when the face of the user is positioned in the operating region during imaging.

9. The iris recognition system of claim 8, further comprising an image signal processor configured to extract a luminance component from the second image data, output the luminance component to the matching unit, extract color space component from the second image data, and output the color space component to the face detection unit, and
wherein the matching unit matches the first image data with the luminance component of the second image data.

10. The iris recognition system of claim 7, wherein the iris recognition device comprises an image sensor including a first sub-pixel group and a second sub-pixel group configured to output the first image data corresponding to an image input via a first lens, and a third sub-pixel group configured to output the second image data corresponding to an image input via a second lens.

11. The iris recognition system of claim 10, wherein an exposure time of pixels included in the first sub-pixel group and the second sub-pixel group is different from an exposure time of pixels included in the third sub-pixel group.

12. The iris recognition system of claim 10, wherein the first lens comprises two narrow-angle lenses, and
the second lens comprises one wide-angle lens,
wherein the two narrow-angle lenses are respectively disposed on the first sub-pixel group and the second sub-pixel group, and
the wide-angle lens is disposed on the third sub-pixel group.

13. The iris recognition system of claim 10, wherein the first image data is based on an infrared-ray image obtained by photographing eyes of the user, and
the second image signal is based on a visible-ray image obtained by photographing the face of the user.

14. The iris recognition system of claim 13, wherein sizes of pixels included in the first sub-pixel group and the second sub-pixel group are greater than sizes of pixels included in the third sub-pixel group.

15. The iris recognition system of claim 13, wherein binning is performed on the pixels included in the first sub-pixel group and the second sub-pixel group to generate a piece of pixel data from data detected from at least two pixels among the pixels.

16. The iris recognition system of claim 7, wherein the iris recognition device comprises one of: a laptop computer, a mobile phone, a smart phone, a tablet personal computer (PC), a personal digital assistant (PDA), an enterprise digital assistant (EDA), a digital still camera, a digital video camera, a portable multimedia player (PMP), a mobile internet device (MID), a wearable computer, an Internet of things (IoT) device, and an Internet of everything (IoE) device.

17. A method of operating an iris recognition system, the method comprising:
outputting first image data and second image data by capturing optical signals configured for recognizing a user's iris;
calculating distance information regarding the user by matching the first image data and the second image data;
calculating spatial information regarding a face of the user, based on the second image data; and
performing iris recognition based on the distance information and the spatial information.

18. The method of claim 17, wherein the performing of the iris recognition comprises:
determining whether the face of the user is positioned in an operating region during image collection, based on the distance information and the spatial information; and
determining whether the first image data is substantially identical to predetermined image data when the face of the user is positioned in the operating region during image collection.

19. The method of claim 17, wherein the first image data corresponds to an infrared-ray image obtained by photographing eyes of the user, and
the second image data corresponds to a visible-ray image obtained by photographing the face of the user.

20. The method of claim 17, wherein a first party provides the first image data and the second image data; and a second party performs calculation of distance information and spatial information, performs the iris recognition and provides a result.
